(19) United States
(12) Patent Application Publication
(10) Pub. No.: US 2020/0019914 A1
(43) Pub. Date: Jan. 16, 2020

(54) SYSTEMS AND METHODS FOR IMPLEMENTING ACTIONS BASED ON ACTIVITY DATA ACQUIRED DURING A POINT OF SALE FUNCTION

(71) Applicant: Toshiba Global Commerce Solutions Holdings Corporation, Tokyo (JP)

(72) Inventors: Susan Winter Brosnan, Raleigh, NC (US); Daniel Robert Goins, Wake Forest, NC (US); Dean Frederick Herring, Youngsville, NC (US); Patricia Stephany Hogan, Raleigh, NC (US); Jessica S. K. Snead, Cary, NC (US)

(21) Appl. No.: 16/031,042

(22) Filed: Jul. 10, 2018

(51) Int. Cl. G06Q 10/06; G06Q 20/20

(52) U.S. Cl. CPC G06Q 10/06398; G06Q 20/20

(57) ABSTRACT

Systems and methods for implementing actions on activity data acquired during a POS function are disclosed. According to an aspect of the present disclosure, a method includes receiving, by one or more processors, activity data acquired by a wearable device worn by a user during a POS function. The method also includes analyzing, by the processor(s), the activity data in comparison to a stored model of user activity during the POS function. Further, the method includes executing an action based on the analysis of the activity data.

### TECHNICAL FIELD

The presently disclosed subject matter relates to POS (point of sale) systems. More particularly, the presently disclosed subject matter relates to systems and methods for implementing actions based on activity data acquired during a POS function.

### BACKGROUND

In retail environments, POS terminals are commonly used by retail personnel for conducting purchase transactions with customers. These systems are technologically upgraded with software and hardware components to track sales, cash flow, food inventory, and can help simplify the purchase transactions in the retail environment. Users of POS terminals typically receive training pertaining to the standard operating procedures of each POS terminal in operation. It is important to the retailer that the users abide by their training in order to maximize workflow and eliminate system processing errors.

Users of POS terminals may be observed by managers to ensure the users are abiding by standard operating procedures. For example, a manager may directly observe the user's activity during POS functions (e.g., conducting a purchase transaction), or utilize equipment such as a camera for more conveniently observing the user's activity. Based on these observations, the manager may provide suggestions to the POS user to improve performance. Despite the advantages of current technologies for observing POS user activity, there is a continuing need for improved systems and techniques for observing and analyzing such activity.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for implementing actions on activity data acquired during a POS function. According to an aspect of the present disclosure, a method includes receiving, by one or more processors, activity data acquired by a wearable device worn by a user during a POS function. The method also includes analyzing, by the processor(s), the activity data in comparison to a stored model of user activity during the POS function. Further, the method includes executing an action based on the analysis of the activity data.

According to another aspect of the present disclosure, a method includes receiving, by one or more processors, activity data from a wearable device worn by a user during a POS function. The method also includes constructing a model of user activity based on the activity data. Further, the method includes storing, in memory, the constructed model of user activity; and using the stored model for comparison to another user's activity during the POS function for performance analysis of the other user.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of a POS terminal according to embodiments of the present disclosure;

FIG. 2 is a flow chart of an example method for tracking and rendering personnel body movements at POS terminals in accordance with embodiments of the present disclosure;

FIG. 3 is a flow chart of an example method for tracking, constructing and comparing personnel body movements at POS terminals in accordance with embodiments of the present disclosure;

FIG. 4 is a flow chart of an example method for constructing and comparing a three-dimensional model based on user body movements at POS terminals in accordance with embodiments of the present disclosure;

FIG. 5 is a flow chart of an example method for constructing and overlaying an augmented reality image over a three-dimensional model based on user body movements at POS terminals in accordance with embodiments of the present disclosure;

FIG. 6 is a perspective view of an example user of a POS terminal with wearable activity tracking devices being used to capture activity data in accordance with embodiments of the present disclosure; and

FIG. 7 is an overhead view of an example POS terminal being displayed with a constructed augmented reality 3D model based on POS operator and customer body movements at POS terminals in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to denote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

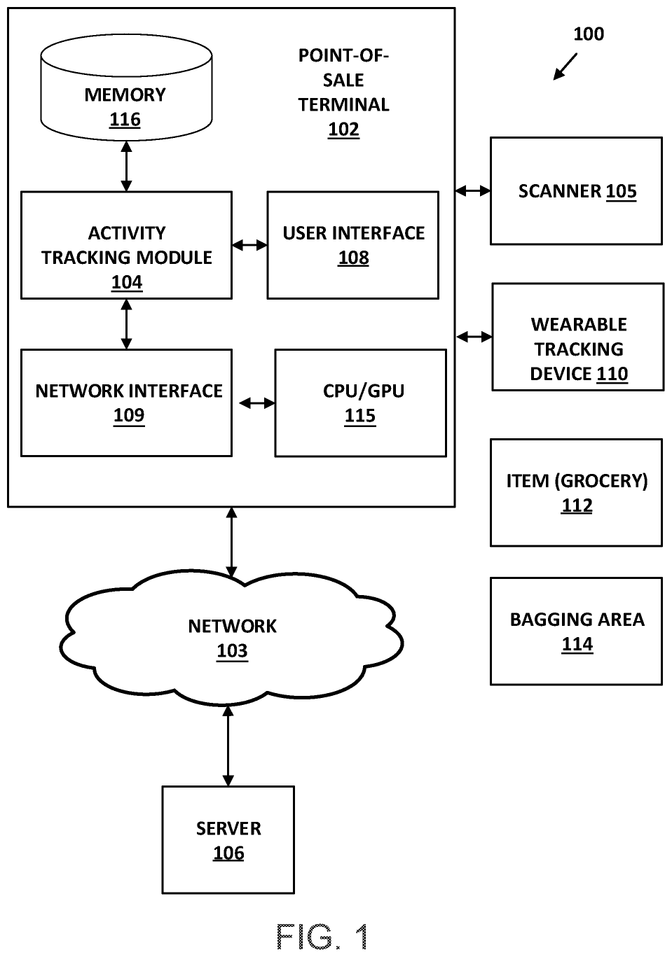

FIG. 1 illustrates a block diagram of a purchase transaction system or POS system 100 according to embodiments of the present disclosure. The system 100 may be implemented in whole or in part in any suitable purchase environment for conducting purchase transactions. For example, the system 100 may be implemented in any retail or grocery store capable of utilizing a POS terminal. Referring to FIG. 1, the system 100 may include a POS terminal 102 that may include an activity tracking module 104, such as a POS application. The POS terminal 102 may be communicatively coupled to a scanner 105, a user interface 108, and a wearable tracking device 110. The activity tracking module 104 may be an application that executes on a processor 115 of the POS terminal 102. The processor 115 may be a dual processor which includes a graphical processing unit (GPU) for rendering pixel frames of video data, three-dimensional (“3D”) objects, augmented reality images that can overlay over a model image, 3D model, or real-world scene and the like. The POS terminal 102 may include any suitable hardware, software, and/or firmware for implementing functions and processes in accordance with embodiments of the present disclosure. The system 100 may include any number of transaction terminals, and only one transaction terminal is shown in FIG. 1 for convenience of illustration.

The scanner 105 may be capable of reading a machine-readable image representing data from an item 112 for purchase. The scanner 105 may be a handheld device that can be passed over a barcode (e.g., a universal product code (UPC) or any other machine-readable image) on the item 112 or may be built into a counter or platform whereby products are passed over the scanner. Further, the scanner 105 may read data from purchase items and transmit the data to the transaction terminal 102 via, for example, a wireless or wireline connection. In an example, the machine-readable image on the item 112 may represent identification of the purchase item. Identification of the item may alternatively be provided to the transaction terminal by, for example, a user entering an identifier, such as a number, representing the item. The identification may be used for accessing data associated with the purchase item, such as, but not limited to, information for determining a category or pricing of the item 112.

The user interface 108 may include a keyboard device or touch display keyboard that enables a shopper to input account and payment information for processing by the transaction terminal 102. For example, the user interface 108 may include a scanning device with a keypad for reading a shopper's financial card (e.g., credit card or debit card) including account number. The user interface 108 may be rendered on a display (not shown) attached to the POS terminal 102. The keypad device on the financial card scanning device may enable a shopper to enter a personal identification number (PIN) if using a debit card or other financial card that requires the PIN be entered. The user interface 108 may include the display for displaying purchase and transaction information to the shopper. For example, the user interface 108 may be a touchscreen display for displaying text and graphics and for receiving user input. The user interface 108 may be communicatively coupled to the transaction terminal 102 via wireless or wireline elements.

The wearable tracking device 110 may detect, capture, and transmit the movements of a user of the POS terminal wearing the device 110. Non-limiting examples of the wearable tracking device 110, include, but are not limited to smart watches including those running ANDROID WEAR®, APPLE WATCH®, and PEBBLE WATCH®, GPS tracking, motion tracking, and fitness tracking bands by FITBIT®, JAWBONE®, RUNTASTIC®, MIO®, BASIS®, MISFIT®, NIKE®, MICROSOFT®, and GARMIN®. Additional examples may include smart-glasses such as GOOGLE GLASS®, and SONY SMART EYE GLASS®, smart fabric woven into the items the cashier is wearing. The wearable tracking device 110 can be worn on the user's wrist, arm, chest, leg, neck, eyes, head, or any extremity of the human body. The wearable tracking device 110 can also be attached to clothing or any other component affixed to the user. The wearable tracking device 110 can be configured to capture movements of the user in real-time, synchronously or asynchronously. Further, for example, the wearable tracking device 110 may capture body motions and movements which may include arm movements, wrist movements, weight, dimension, color, and/or other measurements of the user wearing the device 110. Additional body motions may include body motions, up or down or side to side, or twisting, downward hand motions, upward hand motions, a lateral hand motions, a horizontal hand motions, a vertical hand motions, circular hand motions, diagonal hand motions, swiping hand motions. The wearable tracking device 110 may capture and transmit this information, which can be known as activity data, to the activity tracking module 104 communicatively coupled to the POS terminal 110 via wireless or wireline elements (e.g., serial cable, 802.11 technologies, and the like).

The scanner 105 may be capable of reading a machine-readable image representing an identifier from a discount document. The bagging area 114 may be an area associated with the POS terminal in which the user bags or packages the item 112 when conducting a purchasing transaction or activity. Not shown, a discount document may be attached to the item 112 and may include a coupon including a barcode identifying a manufacturer ID, a family code, and a value code. The scanner 105 may be used to scan the barcode of the coupon. The activity tracking module 104 may determine whether the identifier is recognized and whether the coupon corresponds to an item for purchase. The activity tracking module 104 may also capture the motion activities of the user during the purchase activity conducted by the user.

The activity tracking module 104 may store the activity data captured from the wearable tracking device 110 in memory 116, or send it via network interface 109 over network 103 to be stored on the server 106. The stored activity data may be analyzed and compared against a stored model or standardized template depicting an accurate body motion map (to be explained in more detail below) consistent with proper body motions of a user during a given purchase transaction at the POS terminal. Once the activity data is analyzed and compared, the activity tracking module 104 may execute an action which may include constructing a three-dimensional model based on the captured activity data, transmitting a notification to a second computing device via network 103 such as server 106, that the movement of the user or activity data of the user meets or does not meet given criterion, which can include a match or non-match of the captured and stored activity data based on the comparison, transmitting data associated with the analysis to one of the user or another user, or displaying data associated with the analysis to one of the user or another user, or activate a vibrate or beeping feature at the wearable tracking device to notify that the user is in non-compliance with the body movement compared against the stored body movement in the activity tracking module 104. The activity tracking module 104 may also be configured to construct 3D objects and models based on the body motion activity data captured and received from the wearable device. The activity tracking module 104 may overlay an augmented reality image or 3D model constructed based on the activity data over a user or object rendered in a real scene during a purchase transaction at the POS terminal 102. The innovative features and advantages of the present disclosure described herein include, for example: a low cost design that is suitable to the manufacturing of computer peripherals for POS terminals; a lighter-weight hardware concept that provides an optimal product for augmented reality display, 3D object model display, and POS notification from an ergonomic viewpoint; a highly-simplified optical design that provides a relatively accurate and efficient tracking infrastructure; an efficient software and graphical rendering design to allow users receive 3D models compared with received tracking data to accurately identify inappropriate behavior during POS transactions which could result in costly system malfunctions and inefficient check out; etc. The activity tracking module may be stored and executed on the POS terminal 102 or may use another computing device, such as the server 106.

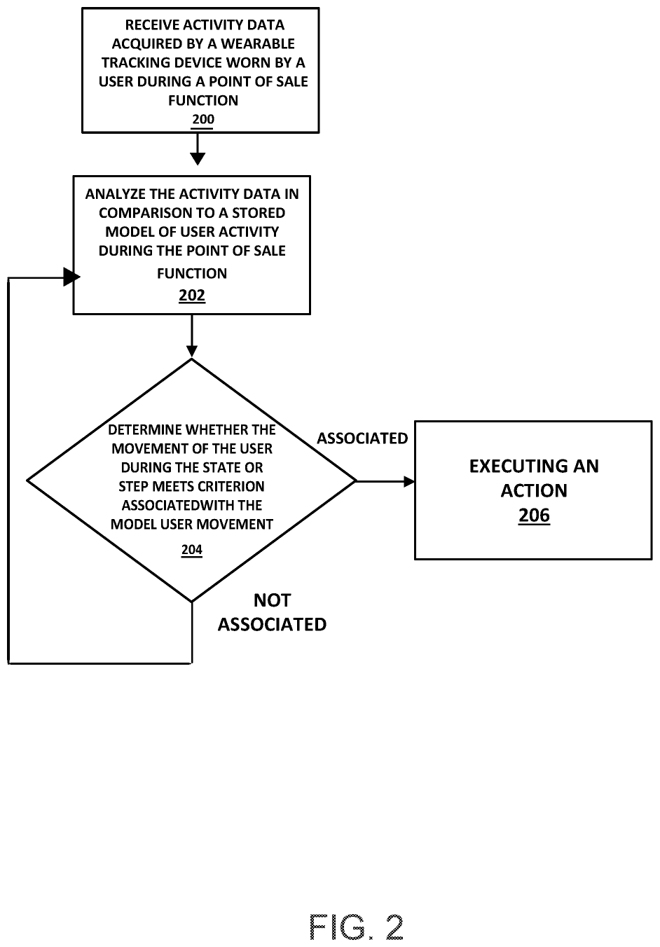

Now turning to FIG. 2, which describes a flow chart of an example method for tracking and rendering user body movements at POS terminals in accordance with embodiments of the present disclosure. The method includes receiving 200, by one or more processors, activity data acquired by a wearable tracking device 110 worn by a user during a POS function. The POS function may correspond to any activity pertaining to or in association with a retail purchase transaction. As a non-limiting example, the POS function may be defined as an assortment of body movements and motions by a user while scanning and bagging items during a POS transaction. As mentioned above, the activity data may be body motions and movements including arm movements, wrist movements, waist movements, weight, dimension, and/or other measurements of the user wearing the device 110. Additional body motions may include downward hand motions, upward hand motions, a lateral hand motions, a horizontal hand motions, a vertical hand motions, circular hand motions, diagonal hand motions, swiping hand motions, and the like. The POS function may correspond to any action, behavior, or motion activities conducted during or associated with a purchase transaction. Activity data acquired may be activity data from a single user wearing the wearable tracking device 110 or multiple users wearing the device 110.

With continuing reference to FIG. 2, the method includes analyzing 202, by the processor(s), the activity data in comparison to a stored model of user activity during the POS function. For example, the method may include comparing the received activity data captured by the wearable device 110 against a model stored in the server 106 or POS terminal. As mentioned above, the received activity data may correspond to body motion captured by the wearable tracking device 110. The model may be a user generated first body motion model that may define a series of action, behavior, or motion activities conducted during or associated with a purchase transaction. The first body motion model may contain a downward hand motion, upward hand motion, lateral hand motion, horizontal hand motion, vertical hand motion, circular hand motion, diagonal hand motion, and/or swiping hand motion as designated by the generator of the model. The model of user activity may also be based on activity data captured from another user of a second wearable device. The activity tracking module 104 may compare the body motions received from the wearable tracking device 110 with the stored model of body motions, e.g. model of user activity.

Still referring to FIG. 2, the method includes determining 204, by the processor, for each state associated with the POS function, whether the movement of the user during the state or step meets one or more criterion associated with the model user movement. The terms “step” and “state” are interchangeable synonyms. The states associated with the POS function may be defined as a sequential and rule-based procedure conducted by a user during a POS transaction. Each state may have one or more body motions associated with the state. For instance, State A may have a swiping hand motion associated with signing on to the POS terminal 102; State B may have a downward and upward hand motion associated with receiving an item 112 for purchase; and State C may have a lateral, vertical, and downward body motion when bagging the item 112 in the bagging area 114. The criterion may be based on timing of the body motions of the user relative to scanning and/or bagging the items 112, the location of the user while conducting the POS transaction, and/or the manner of the user when bagging the items 112 at the end of the transaction, the speed of body motions of the user relative to scanning and/or bagging the item 112 (e.g. user/cashier is moving slowly compared to their peers), the body motions of the user relative to a transition to an error state by the POS Transaction (e.g. user/cashier is still making scanning motions when resolution of unknown bar code is needed), the body motions of the user relative to intervention requested by the POS transaction (e.g. user/cashier is still making scanning motions when quantity entry is required), the body motions of the user relative to a specific action required by the POS transaction state (e.g. user/cashier must check for items at the bottom of the cart prior to starting scanning per company policy, or must ask for customer loyalty card and swipe it), the body motions of the user within a POS transaction state relative to known most efficient body motions (e.g. training for users/cashiers on motions that are most efficient and least likely to cause physical strain), the body motions of the user with item 112 relative to what was expected, but did not occur, in the POS Transaction (e.g. scanning motion made and item placed in bag, but item intentionally or accidentally did not end up in the transaction). When the specified or determined state is associated with the specified criterion, an action is executed 206. The executed action 206 may be an alert in the form of a visual indicator, audio signal, or vibration at the wearable tracking device 110 or another computer device. An action may also include sending notification that the movement of the user meets or does not meet the criterion. If the state of the POS function does not meet the specified criteria, or if the state is not associated with the specified criterion, the method may revert to analyzing the activity data in comparison to the stored model of user activity during the POS function.

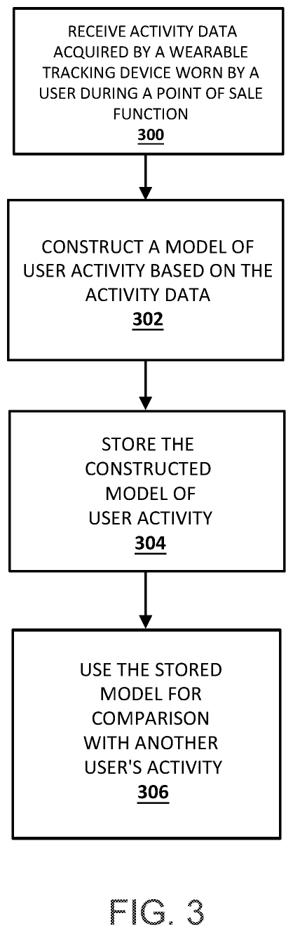

FIG. 3 is a flow chart of an example method for tracking, constructing, storing, and comparing personnel body movements at POS terminals in accordance with embodiments of the present disclosure. As described in FIG. 3, the method includes receiving 300, by one or more processors, activity data acquired by a wearable tracking device 110 worn by a user during a POS function 300. The method also includes constructing 302 a model of user activity based on the activity data. Further, the method includes storing 304 the constructed model of user activity. The method also includes using 306 the stored model for comparison with another user's activity. The POS function may correspond to any activity pertaining to or in association with a retail purchase transaction. As a non-limiting example, the POS function may be defined as an assortment of body movements and motions by a user while scanning and bagging items during a POS transaction. At step 302, the model may be a computer assisted design (CAD) model, a two-dimensional (2D) model, a three-dimensional (3D) model, or any suitable model for representing a user's motion in space. The model is constructed based on the captured user activity data which may be body motions and movements including arm movements, wrist movements, waist movements, weight, dimension, and/or other measurements of the user wearing the device 110. Additional body motions may include downward hand motions, upward hand motions, a lateral hand motions, a horizontal hand motions, a vertical hand motions, circular hand motions, diagonal hand motions, and swiping hand motions. The constructed model may be stored 304 at the POS terminal 102, server 106, a stand-alone computing device (not shown) or at another computing device connected via the network 103 to the POS terminal 102. During the comparison step 306, the constructed model is compared with another user's activity. As described above, another user activity may correspond to a second user of a wearable tracking device 110 during a POS transaction. The other user's activity may compare body motions against the constructed model. For instance, the other user's activity may be a swiping hand motion associated with signing on to the POS terminal 102, a downward and upward hand motion associated with receiving an item 112 for purchase, or a lateral, vertical, and downward body motion when bagging the item 112 in the bagging area 114. The comparison may be based on timing of the body motions of the user relative to scanning and/or bagging the items 112, the location of the user while conducting the POS transaction, and/or the manner of the user when bagging the items 112 at the end of the transaction, the speed of body motions of the user relative to scanning and/or bagging the item 112 (e.g. user/cashier is moving slowly compared to their peers), the body motions of the user relative to a transition to an error state by the POS Transaction (e.g. user/cashier is still making scanning motions when “clear” of unknown bar code is needed), the body motions of the user relative to intervention requested by the POS Transaction (e.g. user/cashier is still making scanning motions when quantity entry is required), the body motions of the user relative to a specific action required by the POS Transactions state (e.g. user/cashier must check for items at the bottom of the cart prior to starting scanning per company policy, or must ask for customer loyalty card and swipe it), the body motions of the user within a POS transaction state relative to known most efficient body motions (e.g. training for users/cashiers on motions that are most efficient and least likely to cause physical strain), the body motions of the user with item 112 relative to what was expected, but did not occur, in the POS Transaction (e.g. scanning motion made and item placed in bag, but item intentionally or accidentally did not end up in the transaction).

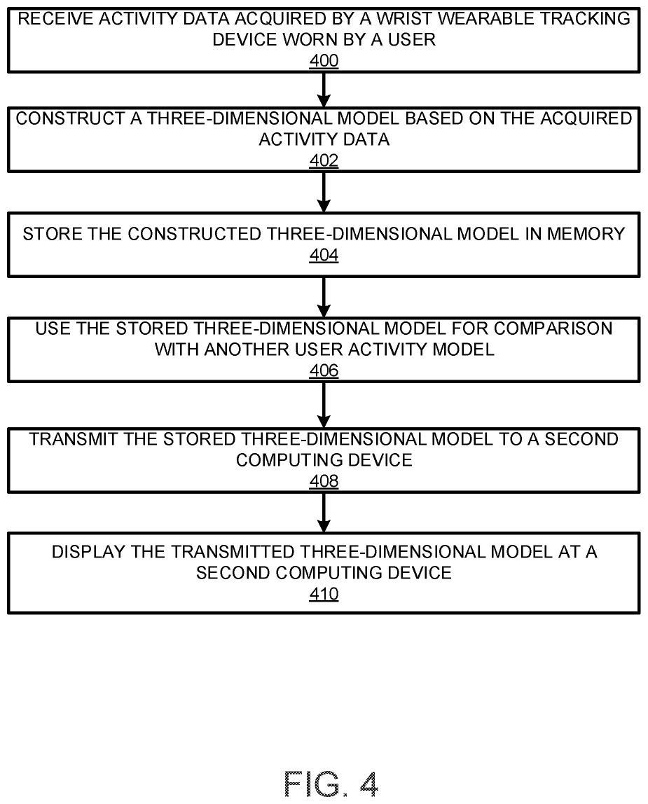

FIG. 4 illustrates a flow chart of an example method for constructing and comparing a three-dimensional model based on user body movements at POS terminals in accordance with embodiments of the present disclosure. The method includes receiving 400 activity data acquired by a wearable tracking device worn by a user. The method also includes constructing 402 a 3D model based on the acquired activity data. Further, the method includes storing 404 the constructed 3D model in memory. The method also includes using 406 the stored 3D model for comparison with another user activity model. The method also includes transmitting 408 stored 3D model to a second computing device. Further, the method 410 includes displaying 410 transmitted 3D model at a second computing device. The model 404 may be any suitable model for representing a user's motion in space. The construction (such as at step 404) of the 3D model may be based on techniques in 3D modeling known in the art which may include generating a wireframe or wire mesh based on the received activity data and later adding surface texture to the wireframe (e.g., color, texture, reflectance, perspective, or the like). The constructed 3D model may be stored (such as at step 404) at memory 116 of the POS terminal 102, server 106, a stand-alone computing device (not shown) or at another computing device connected via the network 103 to the POS terminal 102. The 3D model may be generated to render additional body motions which may include downward hand motions, upward hand motions, lateral hand motions, a horizontal hand motions, a vertical hand motions, circular hand motions, diagonal hand motions, and swiping hand motions. At step 406, the 3D model is compared with another user activity model, such as the user activity model described in FIG. 3 at step 302. The other user activity may correspond to a second user of a wearable tracking device 110 during a POS transaction. The other user's activity may compare body motions against the constructed 3D model. For instance, the other user's activity may be a swiping hand motion associated with signing on to the POS terminal 102, a downward and upward hand motion associated with receiving an item 112 for purchase, or a lateral, vertical, and downward body motion when bagging the item 112 in the bagging area 114. After comparison, the method may continue by transmitting the 3D model to a second computing device via network 103. In an alternate embodiment, a notification to a second computing device via network 103 such as server 106, displaying the 3D model associated with the analysis to one of the user, another user, or second computing device 408. In an alternate embodiment, the method may activate a vibration or beeping feature at the wearable tracking device to notify that the user of a 3D model comparison may be executed.

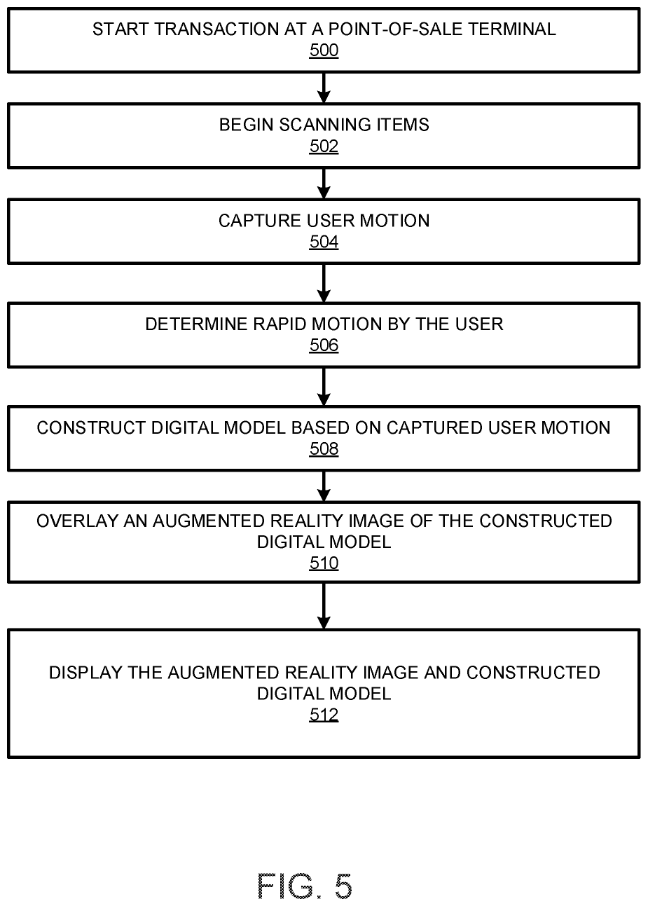

Now turning to FIG. 5, the figure illustrates a flow chart of an example method for constructing and overlaying an augmented reality image over a three-dimensional model based on personnel body. The method begins by starting 500 a transaction at a POS terminal 102. When starting the transaction, a user may sign in at the POS terminal 102 using the wearable tracking device 110 or some other peripheral input component (not shown) that may be attached to the system 100. The method includes scanning 502, by a user, one or more items. The items can be any type of retail item, such as but not limited to groceries, clothing, tools, toys, or any other merchandise associated with a POS function and transaction. The user's motion may be captured 504, typically by the wearable tracking device 110 or some other biometrical device capable of capturing user physical activity or data. The wearable tracking device 110 may also determine various motion levels, speeds, and frequency of the motion conducted by the user. At step 506, the method determines a rapid motion by the user. The rapid motion may be an intense speed or frequency of the hand, arm, or other extremity being measured by the wearable tracking device 114. Still referring to FIG. 5, the method constructs a digital model based on the captured user motion 508 and may then overlay 510 an augmented reality (AR) image of the constructed digital model. The AR image may correspond captured activity data from another user of a wearable tracking device 110. The AR image of the constructed digital model may correspond to additional body motions including downward hand motions, upward hand motions, lateral hand motions, horizontal hand motions, vertical hand motions, circular hand motions, diagonal hand motions, and swiping hand motions. The AR image and constructed digital model may be displayed 512 at the POS terminal 102, at a second computing device in a shared network 103, at another POS terminal 102, or at a stand-alone computing device.

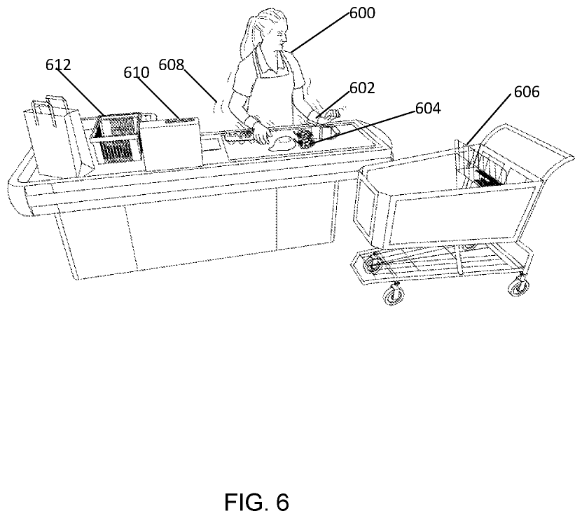

FIG. 6 is a perspective view of an example user of a POS terminal with wearable activity tracking devices being used to capture activity data in accordance with embodiments of the present disclosure. The user 600, as shown in FIG. 6, is a retail employee who is operating a POS terminal 610 during a POS transaction with the bagging area 612 and the shopping cart 606. Although a retail employee is shown, the user 600 may be any individual associated with or directly in contact with a POS transaction. The user 600 is wearing two wearable tracking devices 602 as the user 600 interacts with items 604. User 600 is engaged in varying body motions 608 as she conducts the POS transaction. The wearable tracking device 602 may capture the user's 600 motion.

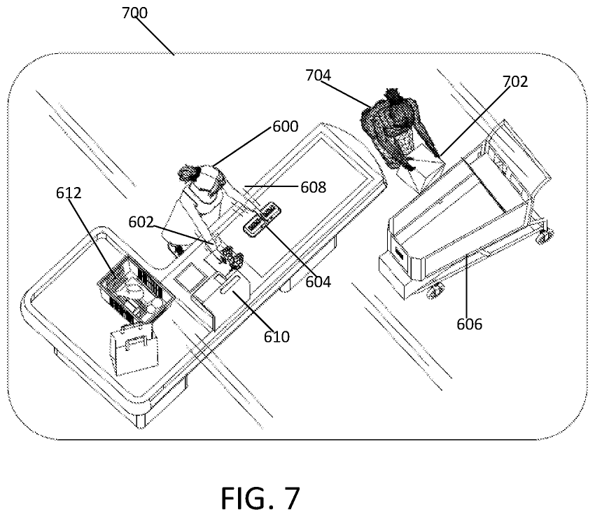

FIG. 7 is an overhead view of an example POS terminal being displayed with a constructed augmented reality 3D model based on user and customer body movements at POS terminals in accordance with embodiments of the present disclosure. As described in FIG. 6, the user 600, is a retail employee operating the POS terminal 610 during the POS transaction. The bagging area 612 is being filled by the user 600 with items 604 as the user 600 wears two wearable tracking devices 602. The constructed customer 3D model 704 is overlaid as an AR image 704. The AR image may correspond to the captured activity data 608 from the user 600 of a wearable tracking device 110. The AR image of the constructed digital model 704 may be rendered to reflect and display additional body motions including downward hand motions, upward hand motions, lateral hand motions, horizontal hand motions, vertical hand motions, circular hand motions, diagonal hand motions, and swiping hand motions. The augmented 3D model 704 may also correspond to a rendered 3D model based on a stored user's body motions as the user initiates a certain portion of the purchase transaction. The 3D model 704 may display the user 600 purported body movements or motions during a given phase or step of the purchase transaction. For example, the 3D model 704 is bending down executing movements during the purchase transaction which include checking under the cart 606 for additional item 604. The AR image and constructed digital model 704 may be displayed at a second computing device 700 in a shared network (such as network 103), a stand-alone computing device or networked server (such as server 106).

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
receiving, by at least one processor, activity data acquired by a wearable device worn by a user during a POS function;
analyzing, by the at least one processor, the activity data in comparison to a stored model of user activity during the POS function; and
executing an action based on the analysis of the activity data.

2. The method of claim 1, further comprising constructing the model of user activity based on one of a state and an order of steps for executing the POS function.

3. The method of claim 2, wherein constructing the model of user activity comprises associating, for each state or step associated with the POS function, a model user movement.

4. The method of claim 3, wherein the activity data indicates movement of the user during the POS function, and
wherein analyzing the activity data comprises determining, for each state or step associated with the POS function, whether the movement of the user during the state or step meets criterion associated with the model user movement associated with the state or step, and
wherein executing the action comprises executing the action based on whether the movement of the user meets the criterion associated with the model user movement, and
wherein analyzing the action and the associated POS function state transition meets the criterion associated with the POS state transition model.

5. The method of claim 4, wherein executing the action comprises sending notification that the movement of the user meets or does not meet the criterion.

6. The method of claim 1, wherein receiving activity data comprises receiving activity data acquired from one of a wrist wearable device, a chest wearable device, a head wearable device, an arm wearable device, a finger wearable device, or a device woven into or attached to clothing.

7. The method of claim 1, wherein executing the action comprises transmitting data associated with the analysis to one user or other users.

8. The method of claim 1, wherein executing the action comprises displaying data associated with the analysis to one of the user or another user.

9. The method of claim 8, wherein the data indicates conformance of one or more movements of the user to the stored model of user activity during the POS function.

10. A method comprising:
receiving, by at least one processor, activity data from a wearable device worn by a user during a POS function;
constructing a model of user activity based on the activity data;
storing, in memory, the constructed model of user activity; and
using the stored model for comparison to another user's activity during the POS function for performance analysis of the other user.

11. The method of claim 10, further comprising:
constructing, by the at least one processor, a three-dimensional video based on the model; and
display, at a remote computing device, the three-dimensional video.

12. The method of claim 10, wherein the activity data comprises one or more body motions acquired by the wearable device.

13. The method of claim 11, wherein one of the body motions comprises one of a downward hand motion, an upward hand motion, a lateral hand motion, a horizontal hand motion, a vertical hand motion, circular hand motion, diagonal hand motion, and a swiping hand motion, any body motion or movement including stepping side to side, back and front, bending up and down or twisting.

14. The method of claim 11, wherein the model comprises a motion map.

15. The method of claim 14, wherein the motion map indicates a plurality of movements, a sequence of two or more of the movements, and a timing of two or more of the movements captured from the wearable device during the POS function.

16. The method of claim 10, further comprising determining, by the processor, whether the activity data is associated with a POS function.

17. The method of claim 10, further comprising determining whether the movement of the user during the state or step meets criterion associated with the model user movement associated with the state or step.

18. The method of claim 10, further comprising:
constructing, by the at least one processor, a three-dimensional video based on the model; and
generating a digital representation of the user based on the three-dimensional video.

19. The method of claim 18, wherein the digital representation of the user comprises body movement information.

20. A system comprising:
a wearable tracking device;
an activity tracking module comprising at least one processor and memory, wherein the memory is configured, with the processor, to:
receive activity data from the wearable device worn by a user during a POS function;
construct a model of user activity based on the activity data and the related POS state;
store, in memory, the generated model of user activity; and
use the stored model for comparison to another user's activity during the POS function for performance analysis of the other user.
